(19) United States
(12) Patent Application Publication
(10) Pub. No.: US 2003/0131150 A1
(43) Pub. Date: Jul. 10, 2003

(54) Installing device driver through web page

(75) Inventor: Takayuki Sugiura, Hyogo (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/327,026

(22) Filed: Dec. 24, 2002

(30) Foreign Application Priority Data
Jan. 7, 2002 (JP) 2002-641

(51) Int. Cl. G06F 13/10

(52) U.S. Cl. 709/321

(57) ABSTRACT

A information processing apparatus and a device are connected via a network. When it is determined that a driver of a device is not installed in the information processing apparatus, a Web page for installing the driver is sent from the device to the information processing apparatus. An installer execution file for installing a driver is sent from the device to the information processing apparatus. When the driver is installed in the information processing apparatus, information indicating that the driver is installed is written into a browser information area.

### FIELD OF THE INVENTION

The present invention relates to installing driver software for a network device, and in particular to installing, through a Web page, driver software for a device, such as a printer, a scanner and the like, connected to the network, in an information processing apparatus connected to the network.

### BACKGROUND OF THE INVENTION

In order to use a device, such as a printer, a scanner and a file device, connected to a LAN (local area network) through a client personal computer (PC) connected to the LAN, a user of the PC needs to first install driver software for the device in the PC using an installer software by inserting a CD-ROM into a CD drive or by designating a directory on the network as a storage location. When installing the driver, each user must enter a predetermined device identifier, such as an IP address or a host name of the device, a predetermined device type, such as a device name and a device model identification determined by a manufacturer, and user's selections related to desired functions or property of the device, as setting information in the driver.

However, the user may not be able to find the CD-ROM which stores the driver software or the storage location on the network. The user is often unfamiliar with installing the driver software, and may make a mistake in operation. For the purpose of installing the driver on the client PC, it is not efficient to allow each user to enter his or her setting information in the driver.

The inventor has recognized that it is advantageous to allow driver software for the device, such as the printer, the scanner and the like, connected to the network to be installed in the information processing apparatus connected to the network, by accessing a Web page.

An object of the present invention is to allow a driver of the network device to be installed in the information processing apparatus through a Web page.

Another object of the invention is to allow to determine whether or not a driver of a network device is installed on the information processing apparatus in accordance with Web browser information.

### SUMMARY OF THE INVENTION

In accordance with one aspect of the present invention, an information processing apparatus is connectable to a network device via a network. The information processing apparatus includes a processor, a memory and a display device. The memory has a browser information area. A Web browser and writing means are implemented on the processor. The writing means writes, into the browser information area, information indicating that the driver is installed, when the driver of the device is installed in the information processing apparatus.

In accordance with another aspect of the invention, a network device is connectable to an information processing apparatus via a network. The network device comprises Web server means, and a memory for storing a Web page for installing a driver of the device. The Web server means receives browser information of the information processing apparatus. The Web server means sends the Web page to the information processing apparatus, when it is determined that the driver is not installed in the information processing apparatus.

In accordance with a further aspect of the invention, a network device is connectable to an information processing apparatus via a network. The network device comprises a memory for storing a first Web page including a hyperlink to a second Web page for installing a driver of the device, and a Web server means for sending a device identifier of the device and the first Web page to the information processing apparatus.

In accordance with a still further aspect of the invention, an information processing apparatus is connectable to another information processing apparatus via a network. The information processing apparatus includes Web server means, a memory for storing a Web page used for installing a driver of a network device, and an installer execution file, and means for writing a device identifier of the device into an area in the installer execution file or the driver. When a driver of the device is not installed in the other information processing apparatus, the Web server means sends the Web page to the other information processing apparatus.

In accordance with a still further aspect of the invention, a program (which may be stored on a storage medium) is for use in an information processing apparatus connectable to a network device via a network. The program is operable to effect the step of sending information within a browser information area to the device, and the step of writing, into the browser information area, information indicating that a driver of the device is installed, when the driver is installed in the information processing apparatus.

In accordance with a still further aspect of the invention, a program (which may be stored on a storage medium) is for use in a network device connectable to an information processing apparatus via a network. The program is operable to effect the step of receiving browser information of the information processing apparatus, and the step of sending a Web page used for installing a driver of the device to the information processing apparatus, when it is determined that a driver of the device is not installed in the information processing apparatus.

In accordance with a still further aspect of the invention, a program (which may be stored on a storage medium) is for use in a network device connectable to an information processing apparatus via a network. The program is operable to effect the step of sending a device identifier of the device to the information processing apparatus; and the step of sending a first Web page including a hyperlink to a second Web page used for installing a driver of the device to the information processing apparatus.

In accordance with a still further aspect of the invention, a program (which may be stored on a storage medium) is for use in an information processing apparatus connectable to another information processing apparatus via a network. The program is operable to effect the step of sending a Web page used for installing a driver of the device to the other information processing apparatus, when a driver of a network device is not installed in the other information processing apparatus, the step of writing a device identifier of the device into an area within an installer execution file for installing the driver or within the driver, and the step of sending the installer execution file to the other information processing apparatus.

According to the invention, a driver of the network device can be installed in the information processing apparatus through a Web page, and whether a driver of a network device is installed in the information processing apparatus can be determined in accordance with Web browser information.

### BRIEF DESCRIPTION OF THE DRAWINGS

FIG. 1 shows a network configuration including a client personal computer, a network device, a file server computer, and a Web server computer, which are interconnected via a network.

FIG. 2 shows structures or organizations of an installer execution file and a driver file, in accordance with the invention.

FIG. 3 shows another structure of the installer execution file, in accordance with the invention. As shown in the figure, the installer execution file may include a block of device driver software.

FIG. 4 shows an area of Web browser information which has a sub-area of a device identifier, and a sub-area of installation information.

FIG. 5 shows configurations of the PC and the device, in accordance with a first embodiment of the invention.

FIG. 6 shows a flow chart for installing the driver that is executed by the PC and the device.

FIG. 7 shows a flow chart for recording the fact that the driver is installed, in the area of the Web browser information, that is executed by the installer execution file running on the processor.

FIG. 8 shows another flow chart for recording the fact that the driver is installed, into the Web browser information area, that is executed by the device monitoring application.

FIG. 9 shows configurations of the PC and the device, in accordance with a second embodiment of the invention.

FIG. 10 shows configurations of the PC, the device and the file server, in accordance with a third embodiment of the invention.

FIG. 11 shows configurations of the PC, the device and the Web server, in accordance with a fourth embodiment of the invention.

FIG. 12 shows a flow chart for installing the driver that is executed by the PC and the device in FIG. 11.

FIG. 13 shows a flow chart following that of FIG. 12 for installing the driver that is executed by the PC and the Web server in FIG. 11.

### DESCRIPTION OF THE PREFERRED EMBODIMENTS

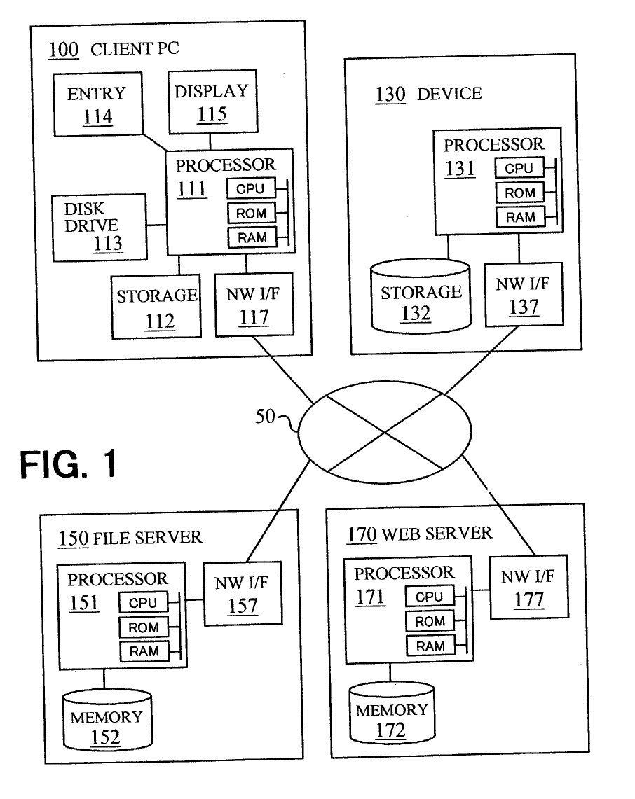

FIG. 1 shows a network configuration including a client personal computer (PC) 100, a network device 130, such as a printer, a scanner, a digital camera and a file device, a file server computer 150, and a Web server computer 170, which are interconnected via a network 50, such as a local area network (LAN) . The network 50 may have any physical form, and may be a wire LAN, a wireless LAN or an optical fiber LAN, for example. The network 50 may include other client PCs and the network devices, which are not shown in the figure. Throughout FIGS. 1-13, similar symbols and numerals indicate similar elements.

The client PC 100 includes a processor 111 having a CPU, a ROM and a RAM, a storage device 112, such as a hard disk device, a disk drive 113, such as a CD drive, an entry or input device 114, such as a keyboard and a mouse, a display device 115, and a network interface 117 connected to the network 50. The storage device 112 stores an operating system (OS) of the PC 100, a Web browser application and an application, such as an installation information setting application which will be described later, and a received Web page. The OS and the applications are implemented on the processor 111.

The device 130 includes a processor 131 having a CPU, a ROM and a RAM, a storage device 132, such as a hard disk or a nonvolatile memory such as a flash memory, a network interface 137 connected to the network 50, and a main device function portion (not shown) of the device, such as the printer, the scanner, the digital camera or the like. The storage device 132 stores an application, such as a Web server application, and a Web page described in the HTML. The application is implemented on the processor 131.

The file server 150 includes a processor 151 having a CPU, a ROM and a RAM, a memory 152, such as a hard disk device, and a network interface 157 connected to the network 50. The memory 152 stores Web server applications and has a file storage area. The applications are implemented on the processor 151.

A Web server 170 includes a processor 171 having a CPU, a ROM and a RAM, a memory 172, such as a hard disk device, and a network interface 177 connected to the network 50. The memory 172 stores the applications, such as server applications and the like, and a Web page. The applications are implemented on the processor 171.

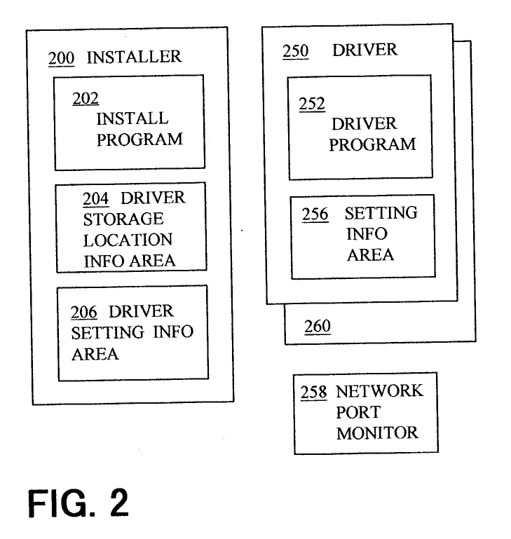

FIG. 2 shows structures or organizations of an installer execution file 200 and a driver file 250, in accordance with the invention. The installer execution file 200, which has extension represented typically by “.exe”, includes blocks of a main install program (codes) 202 for installing a device driver software file 250, an area 204 of information or an identification of a storage location of the driver, and an area 206 of device driver setting information. Thus, the information on the driver storage location is included in the installer execution file 200, so that the information at the driver storage location can be easily obtained when the driver is installed.

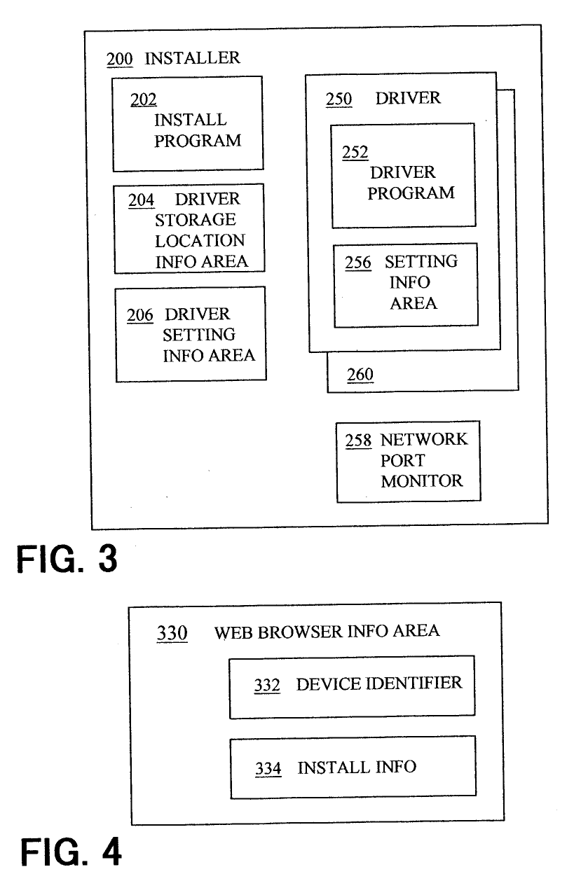

FIG. 3 shows another structure of the installer execution file 200, in accordance with the invention. As shown in the figure, the installer execution file 200 may include a block 250 of device driver software.

The driver software 250 in FIGS. 2 and 3 includes a main driver program (codes) 252 for the specific device (130) and an area 256 of setting information of the driver.

When an operating system (OS) produced by Microsoft® Corporation is used in the PC 100 and the device 130 is a network printer, it is necessary to install a network port monitor software 258 on the PC in addition to the driver 250 for the printer. In this case, the area 204 for of the storage location information also includes the storage location information of the network port monitor 258.

In FIGS. 2 and 3, the installer execution file 200 may install a plurality of drivers 250, 260, . . . , with respective different functions, of the specific device 130. In the area 206, predetermined and desired driver setting information including a device identifier, such as an IP address, a host name or a URL of the device 130, a predetermined device type, such as a device name and a device model identification determined by a manufacturer, and selections related to desired functions or property of the device that are predetermined by an administrator. Thus, the information related to the driver storage location is included in the installer execution file 200, so that the driver storage location information can be easily obtained when the driver is installed.

FIG. 4 shows an area 330 of the Web browser information, such as the Web browser information file or the so-called cookie in the PC 100, which has a sub-area of a predetermined device identifier 332, such as an IP address, a host name or a URL of the device, and a sub-area 334 of installation information indicating whether or not the driver is installed on the PC 100.

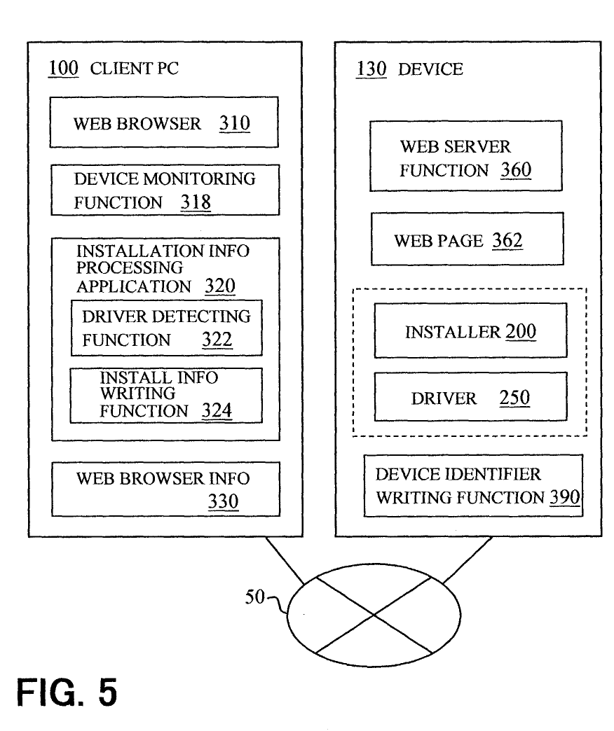

FIG. 5 shows configurations of the PC 100 and the device 130, respectively, in accordance with a first embodiment of the invention. In this embodiment, a Web browser application 310, a device monitoring application 318, an application 320 for processing driver installation information, and the cookie including the Web browser information area 330 are implemented on the processor 111 in the PC 100. The application 320 for processing the driver installation information includes a function 322 for detecting whether or not the driver is installed in the PC 100 and a function 324 for writing the installation information into the sub-area 334 within the browser information area 330 (FIG. 4). The application of the driver installation detecting function 322 and the application of the installation information writing function 324 may be included in separate files, respectively.

In the device 130, the storage device 132 stores a Web page 362 associated with a specific URL, the installer execution file 200, and the driver 250 for the device 130 to be installed by the installer 200. A Web server application 360 and an application 390 for writing a device identifier 332 (FIG. 4) of the device 130 into the setting information area 206 of the installer 200 or into the setting information area 256 of the driver 250 (FIGS. 2 and 3) are implemented on the processor 131.

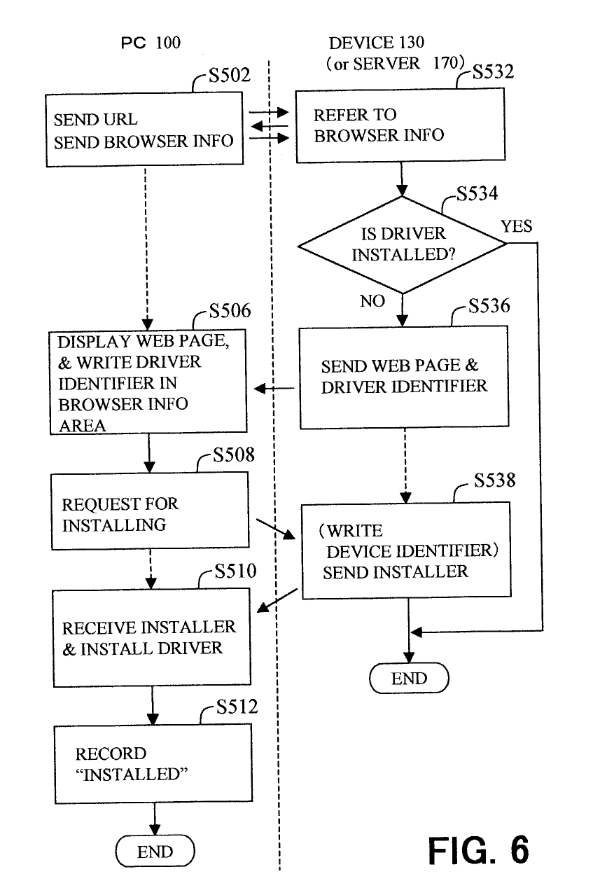

FIG. 6 shows a flow chart for installing the driver 250 that is executed by the PC 100 and the device 130 in combination. In order to install the driver 250 of the device 130, the user activates the Web browser 310 on the PC 100 and enters a URL of the Web page 362 for the installation on a browser screen. When the Web browser 310 is activated, a Web browser information saving function, called the cookie, also operates, unless it is set in a disabled state. At Step 502, the browser 310 sends the URL over the network 50.

At Step 532, in response to reception of the URL, the server function 360 of the device 130 causes the PC 100 to send, to the device 130, the installation information 334 included in the browser information area 330 of the cookie of the PC 100. When the PC 100 is set in such a state that the browser information in the area 330, such as the cookie, is not available, the Web server function 360 sends, to the PC 100, a Web page including a statement, which instructs the user to make the browser information 330 available, before causing the PC to send the installation information. The user makes the browser information area 330 available in the PC 100 in accordance with the instruction.

At Step 534, the Web server function 360 of the device 130 determines whether the driver 250 is installed in the PC 100 in accordance with the installation information 334 (FIG. 4). If it is determined that the driver is installed, the procedure exits from the routine of FIG. 6 and the Web server function 360 sends, to the PC 100, a normal Web page including the device identifier for using the driver 250 (not shown). The browser 310 receives and displays the Web page on the display device 115.

If it is determined that the driver is not installed, the Web server function 360 at Step 536 sends, to the PC 100, the Web page 362 for downloading the driver and a device identifier, such as an IP address, a host name and a URL of the device 130. At Step 506, the browser 310 receives and displays the Web page 362, and the cookie of the PC 100 writes the received device identifier 332 of the device 130 into the browser information area 330. The Web page 362 includes a software button “INSTALL” (not shown) for starting the installation of the driver. When the user clicks the button “INSTALL”, the browser 310 at Step 508 sends, to the device 130, a request for the installation.

Upon receiving the request for the installation, the Web server function 360 at Step 538 stores the installer 200 of FIGS. 2 and 3 or the driver 250 of FIG. 2 in the RAM of the device 130. The device identifier writing function 390 retrieves the device identifier 332 of the device 130 written in the browser information area 330 of the PC 100, and first writes the device identifier 332 into the setting information area 206 or 256 of the installer 200 or the setting information area 256 of the driver 250 which is stored in the RAM. The Web server function 360 then sends the installer execution file 200 to the PC 100.

At Step 510, the browser 310 receives the installer execution file 200 and reads it into the hard disk of the storage device 112 of the PC 100. When it is read into the PC 100, the installer 200 (202) automatically reads the driver 250 from the RAM of the device 130 or from the storage device 132 to install it, and writes the setting information, i.e., the device identifier, the device type and selections of different functions or the property, included in the area 206 of the installer execution file 200, into the setting information area 256 of the driver 250. When the device identifier has already been written in the setting information area 256 of the driver 250, the device identifier in the setting information area 206 of the installer 200 is not required to be written into the area 256.

At Step 512, the browser 310 operates in conjunction with the installer 200 or the device monitoring application 318 to record the fact that the device driver is installed, in the browser information area 330 of the cookie.

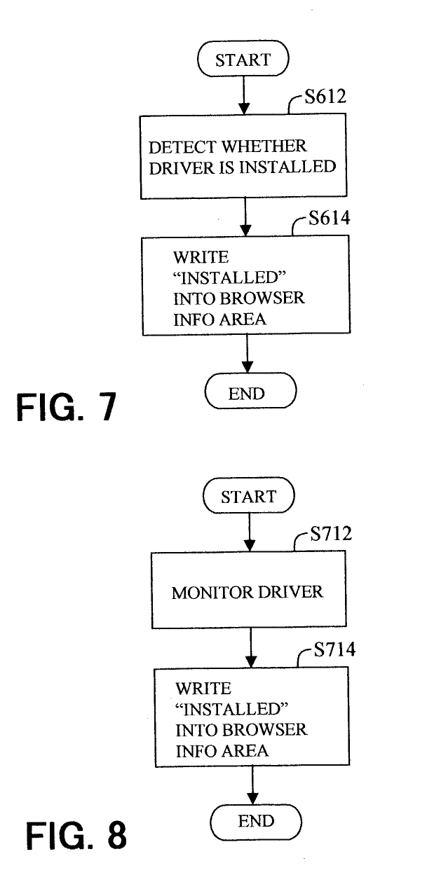

FIG. 7 shows a flow chart for recording the fact that the driver 250 is installed, into the area of the Web browser information 330, that is executed by the installer execution file 200 running on the processor 111. The running installer 200 (202) installs the driver 250 at Step 510 of FIG. 6, invokes the installation information processing application 320, and at Step 612 of FIG. 7 causes the driver detecting function 322 to detect a current installation state of a necessary driver (250). At Step 614, the installation information writing function 324 rewrites the installation information of the sub-area 334 in the browser information area 330 in accordance with the current installation state of the driver, i.e., writes the fact that the driver 250 is installed, into the sub-area 334. This prevents the driver 250 which has already been installed from being re-installed through the Web page by mistake in the future (see Step 534).

FIG. 8 shows another flow chart for recording the fact that the driver 250 is installed, into the Web browser information area 330, that is executed by the device monitoring application 318. The device monitoring application 318 running on the processor 111 operates periodically or at the time of installation of an arbitrary driver, independently of the browser, and at Step 712 monitors the drivers and invokes the installation information processing application 320 to cause the driver detecting function 322 to detect the current installation states of all of the drivers. At Step 714, the installation information writing function 324 rewrites the installation information of the sub-area 334 in the browser information area 330 in accordance with the current installation states of the drivers, i.e., writes the fact that the driver 250 has already been installed, into the sub-area 334. Thus, even when the driver is installed without using the Web browser, the installation information in the sub-area 334 can be written into the browser information area 330. This prevents the driver 250 which has already been installed from being re-installed through the Web page by mistake.

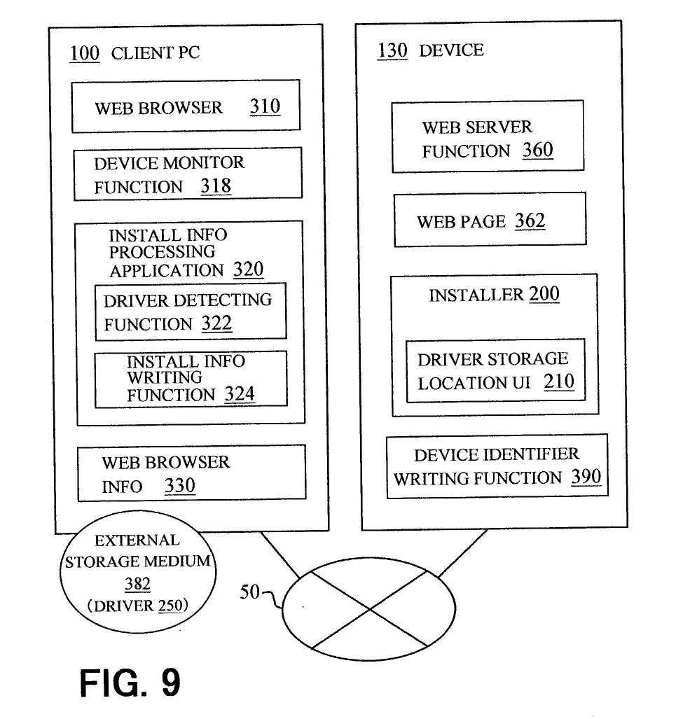

FIG. 9 shows configurations of the PC 100 and the device 130, in accordance with a second embodiment of the invention. In this embodiment, similarly, the Web browser application 310, the device monitoring application 318, the driver installation information processing application 320, and the cookie having the browser information area 330 are implemented on the processor 111 in the PC 100. The user of the PC 100 has an external storage medium 382, such as a CD-ROM, a DVD or the like, storing the driver 250.

In the device 130, the storage device 132 stores the Web page 362 and the installer execution file 200 of FIG. 2. The Web server application 360 and the device identifier writing application 390 are implemented on the processor 131. The installer execution file 200 includes a user interface (UI) 210 for designating a storage location of the driver 250 of the device 130 to be installed by the installer. Thus, the use of the external storage medium 382 storing the driver 250 can minimize a memory capacity required for the device 130.

In this embodiment, at Step 538 of FIG. 6, the Web server function 360 stores the installer 200 of FIGS. 2 and 3 into the RAM of the device 130. The device identifier writing function 390 retrieves the device identifier 332 of the device 130 written in the browser information area 330 of the PC 100, and first writes it in the setting information area 206 of the installer 200 stored in the RAM. The Web server function 360 then sends the installer execution file 200 to the PC 100.

At Step 510, the browser 310 receives the installer execution file 200 and reads it into the hard disk of the PC 100. When it is read into the PC 100, the user interface 210 is first activated and the installer 200 (202) displays a display screen on the display device 115 for designating the storage location of the driver, and allows the user to designate or select the storage location of the driver 250 to be installed. When the user inserts the external storage medium 382 into the drive 113 and designate the external storage medium 382, the user interface 372 displays a list of the drivers stored in it. When the user designates the driver 250 for the device 130, the installer 200 (202) automatically reads the driver 250 from the external storage medium 382 to install it, and writes the setting information included in the area 206 of the installer 200 into the setting information area 256 of the driver 250. The steps in FIG. 6 other than Steps 510 and 538 are executed as described above, and is not described again.

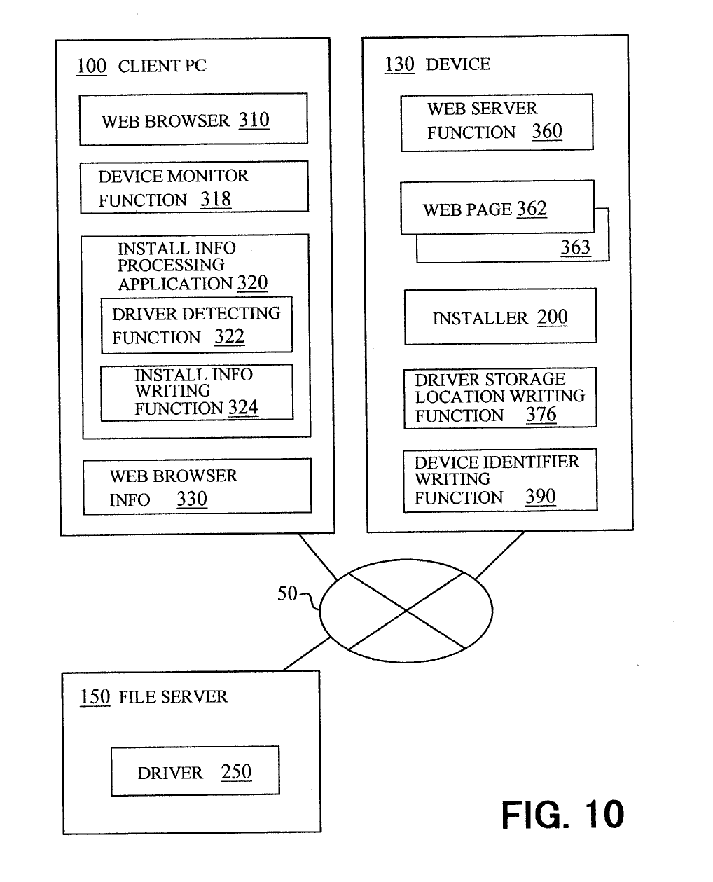

FIG. 10 shows configurations of the PC 100, the device 130 and the file server 150, in accordance with a third embodiment of the invention. In this embodiment, the PC 100 has a similar configuration to that of FIG. 5.

In the device 130, the storage device 132 stores the Web pages 362 and 363 and the installer execution file 200 of FIG. 2. The Web server application 360, an application 376 for writing the storage location information of the driver into the installer, and the device identifier writing application 390 are implemented on the processor 131. The Web page 362 is used for downloading the driver 250, and the Web page 363 is used for designating a storage location of the driver 250.

The storage device 132 of the file server 150 stores the driver 250 of the device 130 to be installed by the installer 200. Thus, placing the driver 250 in the file server 150 can minimize a required memory capacity and a process of the device 130. In addition, the user can install the driver 250 in the PC 100 without knowing the storage location of the driver 250.

In order to preset the installer 200, in the PC for an administrator of the network 50 that has a configuration similar to the PC 100, the administrator uses the Web browser to access and display the Web page 363 for designating the storage location of the driver 250, and writes the storage location of the driver 250 into a storage location field in the Web page. The administrator designates a host name or a directory of the file server 150 as the driver storage location for example. The administrator then may write the IP address, the host name or the URL of the device 130 into the setting information area 206 of the installer 200. When the driver storage location information is designated on the Web page, the driver storage location information writing application 376 of the device 130 is activated and writes the storage location of the driver into the area 204 of the installer 200 stored in the storage device 132.

In this embodiment, at Step 538 in FIG. 6, the device identifier writing function 390 first writes the device identifier 332 of the device 130 written in the browser information area 330 of the PC 100 into the setting information area 206 of the installer 200, and then the Web server function 360 sends the installer execution file 200 to the PC 100.

At Step 510, the browser 310 receives the installer execution file 200 and reads it in the recording medium (e.g. hard disk) of the storage device 112. When it is read in, referring to the driver storage location information area 204, the installer 200 (202) reads the driver 250 from file server 150 as the storage location indicated in the area 204 to install it in the PC 100, then writes the setting information included in the area 206 of the installer 200, into the setting information area 256 of the driver 250. The steps of FIG. 6 other than Step 510 and 538 are executed as described above, and is not described again.

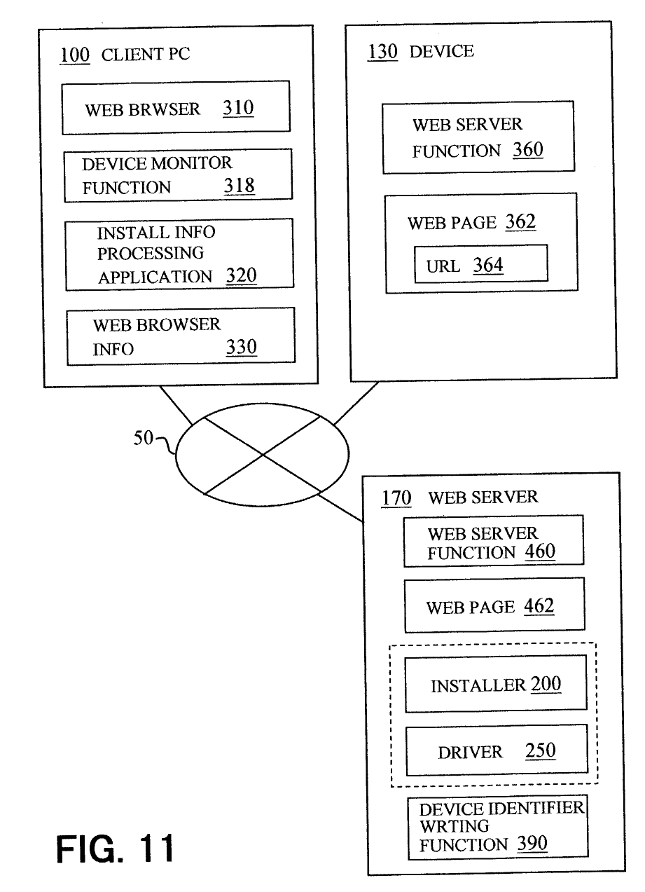

FIG. 11 shows configurations of the PC 100, the device 130 and the Web server 170, in accordance with a fourth embodiment of the invention. In this embodiment, the PC 100 has a similar configuration to that of FIG. 5.

The Web page 362 is stored in the storage device 132, and the Web server application 360 is implemented on the processor 131 in the device 130. A hyperlink URL 364 to a Web page 460 for installing the driver 250 in the Web server 170 is embedded in the Web page 362.

In the Web server 170, the memory 172 stores a Web page 462. associated with a specific URL, the installer execution file 200, and the driver 250 of the device 130 to be installed by the installer 200, and the Web server application 460 and an application 390 for writing the device identifier are implemented on the processor 171. Thus, placing the installer execution file 200, the driver 250 and the device identifier writing application 390 in the Web server can minimize a required memory capacity and operations in the device 130.

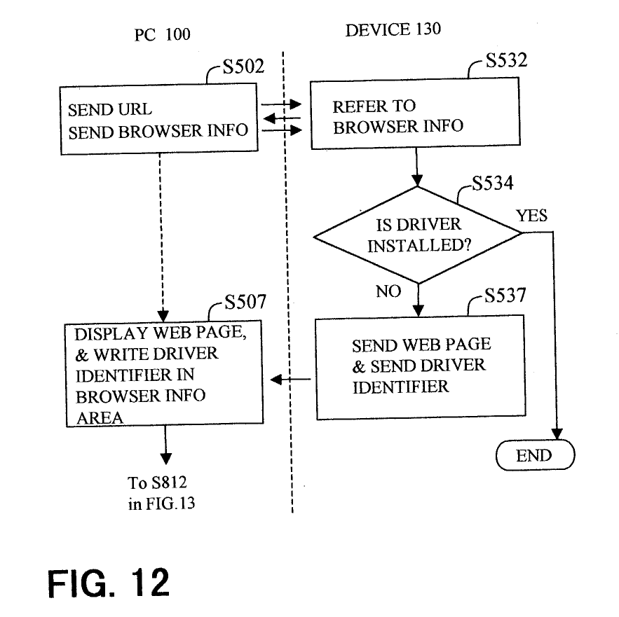

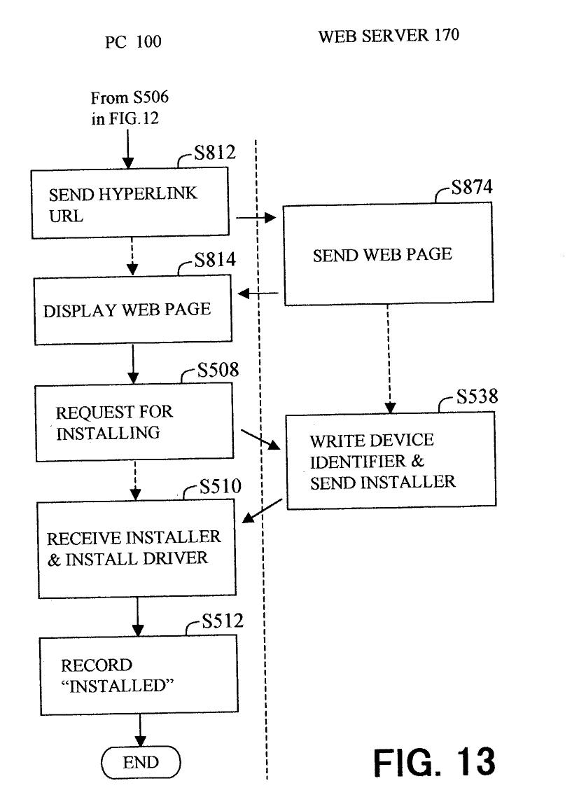

FIG. 12 shows a flow chart for installing the driver that is executed by the PC 100 and the device 130 in FIG. 11. FIG. 13 shows a flow chart following that of FIG. 12, for installing the driver that is executed by the PC 100 and the Web server 170 in FIG. 11. Step 502 of FIG. 12 and Steps 532-534 are similar to those of FIG. 6, and are not described again.

At Step 537 in FIG. 12, the Web server function 360 sends the Web page 362 for downloading the driver and the predetermined device identifier, such as the IP address, the host name or the URL of the device 130, to PC 100. At Step 507, the browser 310 receives and displays the Web page, and the cookie of the PC 100 writes the device identifier 332 of the received device 130 into the browser information area 330. On the Web page, the software button “INSTALL” for displaying the Web page 462 for installing the driver of the Web server 170 is indicated. The hyperlink URL 364 is embedded in the button.

When the user clicks an indication of the button “INSTALL” in the Web page 362, the browser 310 at Step 812 of FIG. 13 sends the URL 364 through the network 50. At Step 874, the server function 460 of the Web server 170 receives the URL 364 and sends the Web page 462 to the PC 100. At Step 814, the browser 310 receives and displays the Web page 462. The software button “CONTINUE INSTALLATION” for starting the installation of the driver is indicated on the Web page 462. When the user clicks the button “CONTINUE INSTALLATION”, the browser 310 at Step 508 sends a request for the installation to the device 130, in the same manner as it does in FIG. 6.

The PC 100 executes Steps 508-512 of FIG. 13 in the same manner as it does in FIG. 6. In FIG. 13, the Web server 170 executes Step 538 of FIG. 6 in the same manner as the device 130 of FIG. 5 does.

Alternatively, the device 130 at Step 537 may send the Web page 362 including the URL 364 without executing the determination of Step 534 of FIG. 12, and the Web server 170 may execute Steps 532 and 534 of FIG. 6 before the sending at Step 874. Thus, in this case, the Web server 170 executes Steps 532-538 of FIG. 6, and the PC 100 executes Steps 502-512 of FIG. 6 following Step 507 of FIG. 12.

The above-described embodiments are only typical examples, and their modifications and variations are apparent to those skilled in the art. It should be noted that those skilled in the art can make various modifications to the above-described embodiments without departing from the principle of the invention and the accompanying claims.

What is claimed is:

1. An information processing apparatus connectable to a network device via a network, said information processing apparatus comprising a processor, a memory and a display device, said memory having a browser information area, said information processing apparatus further comprising:
a Web browser and writing means being implemented on the processor,
said writing means writing, into said browser information area, information indicating that a driver of said device is installed, when said driver is installed in said information processing apparatus.

2. The information processing apparatus according to claim 1, wherein a device identifier of said device is written into said browser information area through said Web browser.

3. The information processing apparatus according to claim 1, wherein a request for installing said driver is sent through said Web browser.

4. The information processing apparatus according to claim 1, wherein an installer execution file for said driver is received through said Web browser and executed, so that said driver is installed.

5. The information processing apparatus according to claim 1, wherein said driver is received through said network and installed.

6. The information processing apparatus according to claim 1, wherein an installer execution file received through said browser reads said driver from an external storage medium to install said driver.

7. The information processing apparatus according to claim 1, wherein an installer execution file received through said browser reads said driver from another apparatus through said network to install said driver.

8. The information processing apparatus according to claim 1, wherein means for detecting whether said driver is installed is implemented on said processor.

9. A network device connectable to an information processing apparatus via a network, comprising:
Web server means, and
a memory for storing a Web page for installing a driver of said device,
said Web server means receiving browser information of said information processing apparatus,
said Web server means sending said Web page to said information processing apparatus, when it is determined that said driver is not installed in said information processing apparatus.

10. The network device according to claim 9, further, comprising, means for writing a device identifier into a setting information area within an installer execution file or a driver stored in said memory.

11. The network device according to claim 9, wherein said memory further stores an installer execution file, and said Web server means sends said installer execution file to said information processing apparatus.

12. The network device according to claim 11, wherein said memory further stores said driver, and said Web server means sends said driver to said information processing apparatus.

13. The network device according to claim 11, wherein said installer execution file comprises an area for indicating a storage location of said driver.

14. The network device according to claim 13, wherein said storage location corresponds to an external storage medium of said information processing apparatus.

15. The network device according to claim 13, wherein said storage location corresponds to another apparatus connected to said network.

16. The network device according to claim 11, further comprising, means for writing a storage location of said driver into said installer execution file stored in said memory.

17. The network device according to claim 9, wherein said Web server means sends a statement which instructs to make browser information available in said information processing apparatus, when said browser information is not available in said information processing apparatus.

18. A network device connectable to an information processing apparatus via a network, comprising:
a memory for storing a first Web page including a hyperlink to a second Web page for installing a driver of said device, and
a Web server means for sending a device identifier of said device and the first Web page to said information processing apparatus.

19. The network device according to claim 18, wherein said first Web page is sent to said information processing apparatus, when it is determined that said driver is not installed in said information processing apparatus.

20. An information processing apparatus connectable to another information processing apparatus via a network, comprising:
Web server means,
a memory for storing a Web page for installing a driver of a network device, and an installer execution file, and
means for writing a device identifier of said device into an area in said installer execution file or said driver,
said Web server means sending said Web page to said other information processing apparatus, when a driver of said device is not installed in said other information processing apparatus.

21. The information processing apparatus according to claim 20, wherein said Web server means further sends said installer execution file to said other information processing apparatus.

22. The information processing apparatus according to claim 20, wherein said device identifier is read from a browser information area in said other information processing apparatus.

23. The information processing apparatus according to claim 20, wherein a URL of said Web page is embedded as a hyperlink in another Web page which said device has.

24. A program stored on a storage medium for use in an information processing apparatus connectable to a network device via a network, said program being operable to effect the steps of:
sending information within a browser information area to said device, and
writing, into said browser information area, information indicating that a driver of said the device is installed, when said driver is installed in said information processing apparatus.

25. The program according to claim 24, being operable to further effect the step of writing a device identifier of said device into said browser information area through said Web browser.

26. The program according to claim 24, being operable to further effect the step of receiving an installer execution file.

27. The program according to claim 24, being operable to further effect the step of detecting whether a driver of said device is installed in said information processing apparatus.

28. A program stored on a storage medium for use in a network device connectable to an information processing apparatus via a network, said program being operable to effect the steps of:
receiving browser information of said information processing apparatus, and
sending a Web page used for installing a driver of said device to said information processing apparatus, when it is determined that said driver is not installed in said information processing apparatus.

29. The program according to claim 28, being operable to further effect the step of determining whether said driver is installed in said information processing apparatus.

30. The program according to claim 28, being operable to further effect the step of writing a device identifier into a setting information area within a installer execution file or a driver.

31. The program according to claim 28, being operable to further effect the step of sending an installer execution file to said information processing apparatus.

32. A program stored on a storage medium for use in a network device connectable to an information processing apparatus via a network, said program being operable to effect the steps of:
sending a device identifier of said device to said information processing apparatus, and
sending a first Web page including a hyperlink to a second Web page for installing a driver of said device to said information processing apparatus.

33. A program stored on a storage medium for use in an information processing apparatus connectable to another information processing apparatus via a network, said program being operable to effect the steps of:
sending a Web page for installing a driver of a network device to said other information processing apparatus, when said driver is not installed in said other information processing apparatus,
writing a device identifier of said device into an area within an installer execution file for installing said driver or in said driver, and
sending said installer execution file to said other information processing apparatus.

34. In a system comprising an information processing apparatus and a network device connectable via a network, a method for installing a driver of said device in said information processing apparatus, comprising the steps of:
sending a Web page for installing the driver of said device from said device to said information processing apparatus, when it is determined that said driver is not installed in said information processing apparatus,
sending an installer execution file for installing said driver from the device to said information processing apparatus, and
writing information indicating that said driver is installed, into a browser information area of said information processing apparatus, when said driver is installed in said information processing apparatus.

35. In a system comprising a first information processing apparatus, a second information processing apparatus and a network device connectable via a network, a method for installing a driver of said device in said first information processing apparatus, comprising the steps of:
sending a first Web page including a hyperlink to a second Web page for installing the driver of said device from said device to said first information processing apparatus,
sending said second Web page from said second information processing apparatus to said first information processing apparatus,
sending an installer execution file for installing said driver from said second information processing apparatus to said first information processing apparatus, and
writing information indicating that said driver is installed, into a browser information area of said first information processing apparatus, when said driver is installed in said first information processing apparatus.
